(19) United States
(12) Patent Application Publication
(10) Pub. No.: US 2013/0043095 A1
(43) Pub. Date: Feb. 21, 2013

(54) Masonry scaffold system with truss level rosettes

(71) Applicant: Stephen H. Thacker, The Woodlands, TX (US)

(72) Inventor: Stephen H. Thacker, The Woodlands, TX (US)

(21) Appl. No.: 13/573,039

(22) Filed: Aug. 15, 2012

Related U.S. Application Data
(60) Provisional application No. 61/575,142, filed on Aug. 16, 2011.
(60) Provisional application No. 61/627,801, filed on Oct. 18, 2011.
(60) Provisional application No. 61/605,426, filed on Mar. 1, 2012.

(51) Int. Cl. E04G 1/15; B23Q 17/00; E04G 7/02

(52) U.S. Cl. 182/186.7; 182/179.1; 29/407.01

(57) ABSTRACT

A scaffold structure having a first end frame with a first vertical member and a second vertical member and a horizontal member, with rosettes on the first and second vertical members, coupled via ledgers to a second end frame with a first vertical member and a second vertical member and a horizontal member, with rosettes on the first and second vertical members. A plurality of said coupled first and second end frames create a bay that can be stacked vertically and coupled horizontally.

### RELATED APPLICATIONS

This application claims priority to U.S. Provisional Application No. 61/575,142 (STHA.0006) entitled Improved MASNONRY SACAFFOLD SYSTEM filed Aug. 16, 2011 and to U.S. Provisional Application No. 61/627801 (STHA.0007) filed on Oct. 17, 2011, entitled “MASONRY SCAFFOLD SYSTEM WITH INTEGRATED ROSETTE” and to U.S. Provisional Application 61/605,426 (STHA.0009) entitled MASONRY SCAFFOLD SYSTEM WITH TRUSS LEVEL ROSETTES filed Mar. 1, 2012.

### FIELD OF THE INVENTION

This invention relates to modular scaffolding systems that are erected as impermanent structures to support platforms. Scaffolding is used, inter alia, in the residential, commercial, industrial, petro-chemical, power source, general industry and residential construction markets.

### BACKGROUND

Conventional scaffolding systems have various components consisting of one or more platforms supported by rigid support members such as poles, tubes, beams, brackets, posts, frames and the like. More specifically, a supported scaffold includes the following components: deck/platform, frame structure, transoms, cross braces, guardrails, toe-boards, wall ties, horizontal members or ledgers, vertical standards and diagonal braces to provide some stiffness and rigidity to the scaffold.

Basic scaffolding elements include three general components: standards, ledgers and transoms. A standard is a long pipe or tube that connects the mass of the scaffold directly to the ground, and it runs the length of the scaffolding. The base of each standard is connected to a base plate, which helps distribute the weight each standard bears. In between each standard, running horizontally is a ledger, which adds further support and weight distribution. Transoms, placed on top of ledgers at a right angle, come in several different forms. Main transoms provide support for standards by holding them in position as well as supporting boards. Intermediate transoms are placed alongside main transoms to lend additional board support.

In addition to standards, ledgers and transoms, there are several other supportive elements that serve to reinforce the fundamental scaffolding. Cross braces, facade braces, and additional couplers, can be used in varying combinations to support the structure in several ways. Cross braces run diagonally between ledgers and securely attach to standards to increase a structure's overall rigidity. However, they can also secure themselves to ledgers, in which case they are simply called ledger braces. Facade braces help prevent a structure from swaying, and are attached on the face of the scaffold, running the length of the face of the structure and securely attaching at every level.

Couplers connect structural elements, and come in several variants. To connect a ledger or transom to a standard, a right-angle coupler is used. If a transom supports a board and must be connected to a ledger, a putlog or single-coupler should be used to connect the ledger to the transom. For any other angle of connection between scaffold piping, a swivel coupler is recommended.

A partially built conventional scaffold 100 is attached hereto as prior art to be compared to the invention. Conventional scaffold 100 shows walk through frame 101, base plates 103 and cross braces 102. As seen therein, the header on a conventional end frame is located at 6′-6″ from the lower end of the vertical member. Conventional scaffold 100 is attached hereto as prior art to be compared to the invention.

### SUMMARY

The invention comprises a new scaffold apparatus that overcomes disadvantages inherent in conventional scaffold systems. The invention advantageously permits an erector to safely and quickly erect a modular scaffold system, preferably for use in a masonry application.

To those skilled in the art to which this invention relates, many changes in construction and widely differing embodiments and applications of the invention will suggest themselves without departing from the scope of the invention as defined herein and in the appended claims. The disclosures and the descriptions herein are purely illustrative and are not intended to be in any sense limiting.

### DESCRIPTION OF THE FIGURES

A more complete understanding of the invention may be obtained by reference to the Detailed Description, when taken in conjunction with the accompanying Figures, wherein:

FIG. 1 illustrates a conventional scaffold;

FIG. 2 illustrates a side view of an end frame of the invention;

FIG. 3 illustrates a side view of stacked end frames comprising the invention;

FIG. 4 illustrates a front view of stacked end frames comprising the invention;

FIG. 5 illustrates a front view of stacked end frames with ledgers comprising the invention;

FIG. 6 is a perspective view of the invention showing two end frames stacked on two end frames creating two elevations;

FIG. 7 is an alternative embodiment of the end frame of the invention;

FIG. 8 is a top view of an end frame showing attached rosettes;

FIG. 9A illustrates a rosette axially coupled to vertical member with an orthogonal horizontal member;

FIG. 9B illustrates a rosette axially coupled to vertical member with two mutually orthogonal horizontal members;

FIG. 10 is a side of an alternative embodiment of an end frame of the invention showing the attachment of additional horizontal members to the rosettes;

FIG. 11 is a first top view of rosette used on the invention;

FIG. 12 is a second top view of the rosette used on the invention;

FIG. 13 is a side view of the rosette coupled to the vertical member of the invention; and

FIG. 14 is a flow chart of the method of the invention.

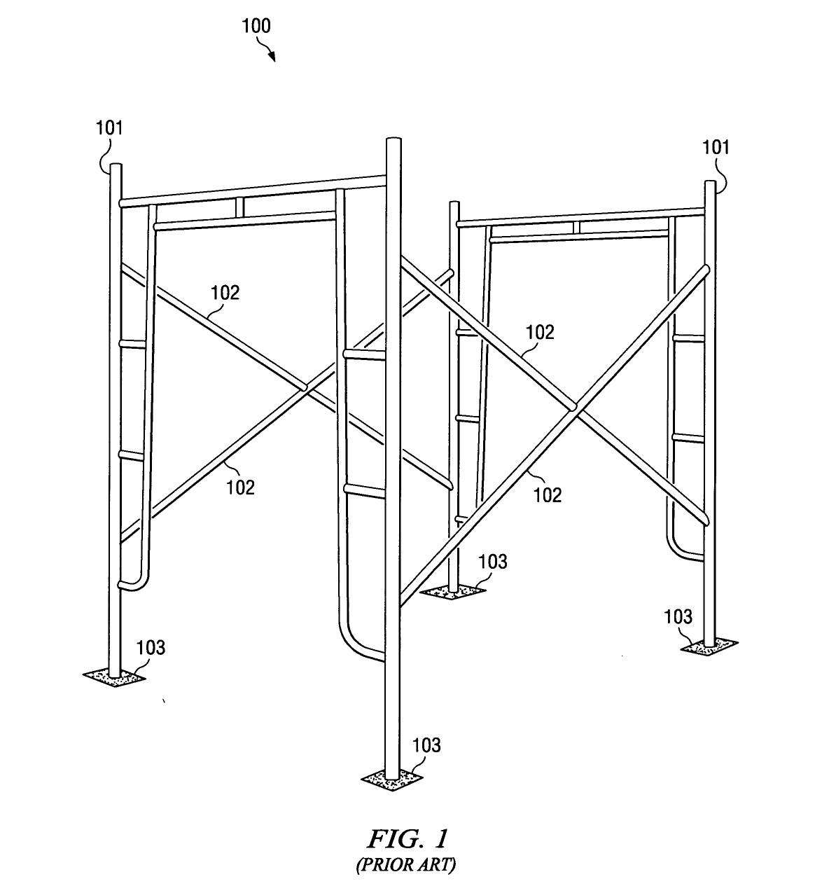

### DETAILED DESCRIPTION

The invention is designed primarily for use as a masonry scaffold, although it is not limited to such application. Because masonry scaffolds need to support the weight of not only workers, but also large loads of blocks, bricks and mortar, only heavy-duty components can be used. Typically, masonry scaffolds will accommodate stress of up to 75 pounds per square foot. Platform widths for masonry scaffolds is fixed preferably at five (5) feet with various lengths ranging from 2′ up to 10′.

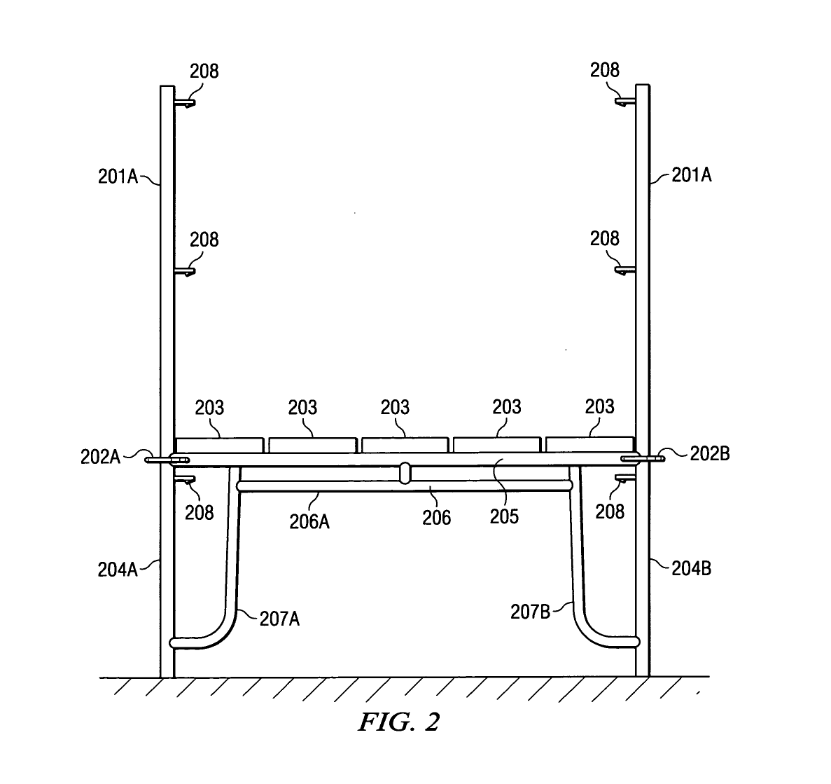

As seen in FIG. 2, an exemplary of end frame 201 the invention is shown with a five (5) foot wide platform defined by five (5), one (1) foot wide plank members 203 laid side by side. Plank members 203, comprised of Fiberglass®, wood or metal planks or walk boards have frame attachment points or members, which are positioned and secured with couplings or within the 4-sided scaffold structure on horizontal members or transoms proximate the header (as described below). Also seen in FIG. 2 is rosette 202 to which ledgers are coupled as further described herein.

More specifically, the invention comprises a base scaffold at a first elevation, the first elevation comprising at least two apositioned end frames as described herein. End frame 201A is comprised of a first vertical member 204A with an upper end and lower end and a second vertical member 204B with an upper end and a lower end. The end frame 201A further comprises a horizontal member 205 having a first end and second end, the first end of the horizontal member welded or coupled orthogonally to the first vertical member 204A, between approximately ⅓ and ⅔ of the length of the first vertical member 204A and the second end of the horizontal member is welded or coupled orthogonally to the second vertical member 204B, also between approximately ⅓ and ⅔ of the length of the second vertical member 204B.

End frame 201A further includes a header or base support comprising a truss arrangement 206 welded below, and parallel to, the horizontal member 205 in the same plane of the horizontal member 205, the truss arrangement 206 being positioned between the first vertical member 204A and second vertical member 204B. The truss arrangement 206 can have an open ended or closed ended corner. The header 206A of truss arrangement 206 is between ⅓ and ⅔ of the distance from the lower end to the upper end of the vertical member.

Below the horizontal member 205 is a first curved brace 207A having a first end thereof welded or coupled proximate to the lower end of the first vertical member 204A, extending orthogonally from the first vertical member 204A and curving up to meet the bottom side of the horizontal member 205, the first curved brace 207A being in the plane of the end frame 201A and a second curved brace 207B below the horizontal member 205 having a first end thereof welded or coupled proximate to the lower end of the second vertical member 204B, extending orthogonally from the second vertical member 204B and curving up to meet the bottom side of the horizontal member 205, the second curved brace 207B being in the plane of the end frame 201A, the end frame 201A being symmetrical along an imaginary vertical axis down the center of the end frame 201A.

Welded, or otherwise coupled to at least one, but preferably each, vertical member 204A, 204B is a rosette 202 configured to receive at least one horizontal cross member, including but not limited to a ledger and/or guardrail, that is orthogonal to the truss arrangement. Each end frame 201A, 201B, 201C, 201D (as explained below) includes respective rosettes 202A, 202B, co-axially positioned on vertical members 204A, 204B. Each rosette 202A, 202B is positioned and then welded or otherwise attached along the vertical member 204A, 204B proximate the truss arrangement 206 level providing connections for ledgers, horizontal members and/or diagonal braces. The rosettes 202 attached to end frames 201 are more fully described herein.

Each of first vertical member 204A and second vertical member 204B further have coupling points, mounts, or attachment points 208 (referred to collectively as coupling points herein) disposed along each of their extent to receive connection members, braces, handrails and/or knee rails as further described herein.

For purposes hereof, a second end frame shall have the same components as end frame 201A, and end frame 201A shall refer to first end frame 201A and the second end frame shall be referred to as second end frame 201B. A third end frame stacked on first end frame 201A shall have the same components as end frame 201A and shall be referred to as third end frame 201C and fourth end frame stacked on second end frame 201B shall have the same components as end frame 201A and shall be referred to as fourth end frame 201D

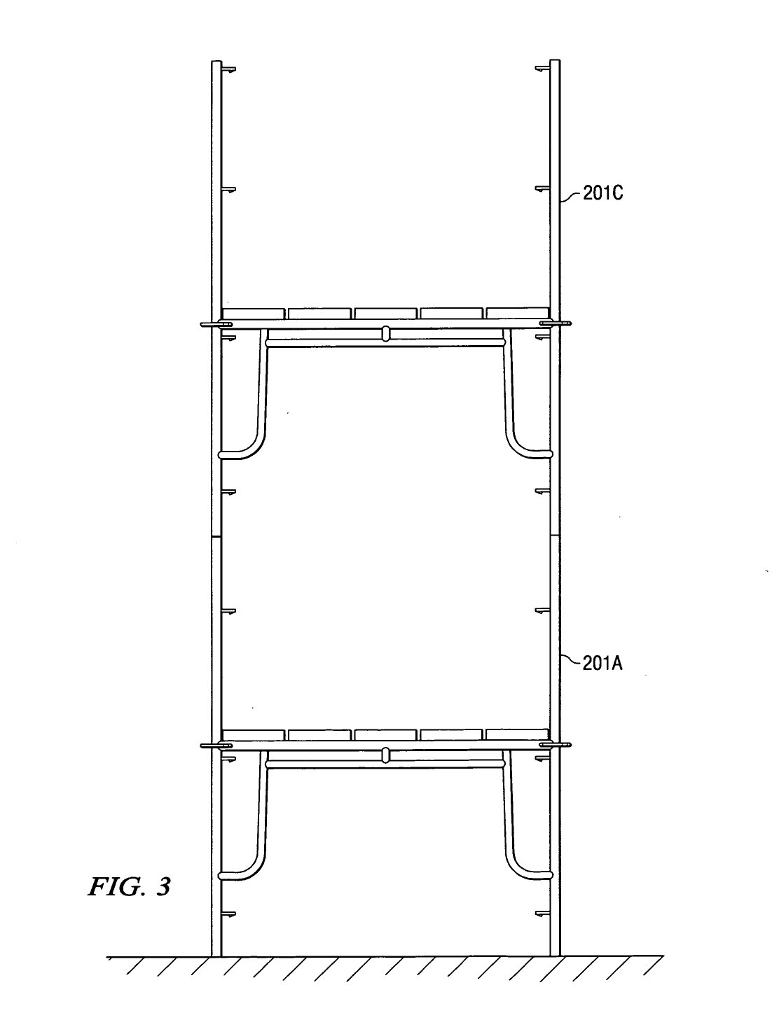

In a further embodiment, a second elevation of the 4-sided base scaffold structure 201C can be assembled on top of the first elevation 201A as seen in FIG. 3. In such case, the lower ends of the vertical members of the second elevation have coupling mechanisms, including but not limited to collars configured to be engaged to the upper ends of respective vertical members of the first elevation as further described below. Alternatively the collars can be located on the upper ends of the vertical members of the first elevation and dimensioned to receive the lower ends of the vertical members of the second elevation.

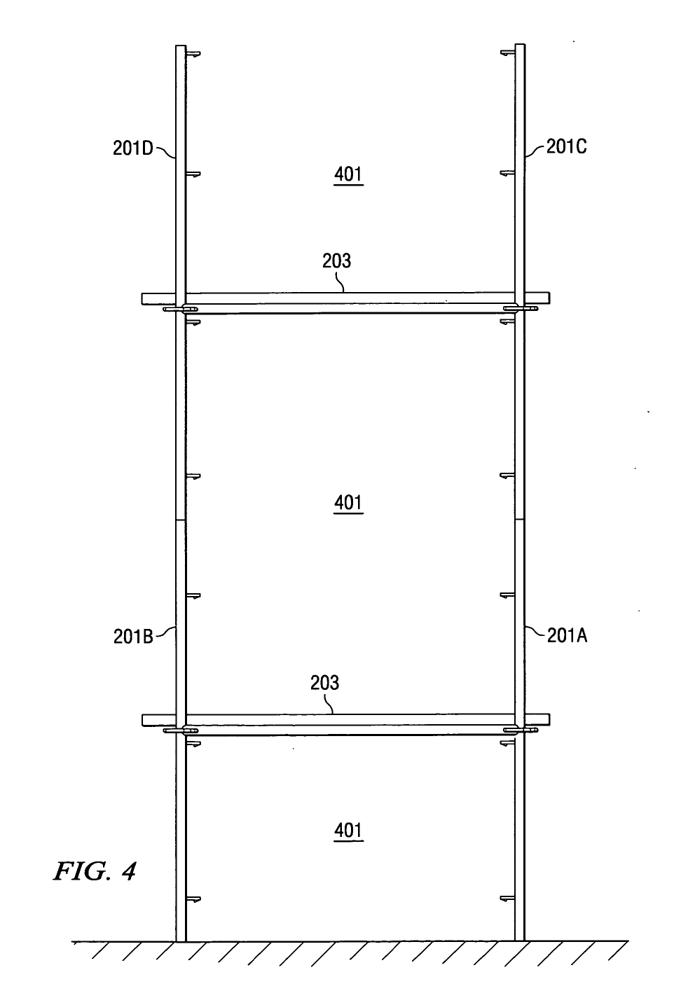

Referring now to FIG. 4, in a front view, end frame 201C is shown stacked on end frame 201A and end frame 201D is shown stacked on end frame 201B. The platform 203 and the end frames 201 define bays 401.

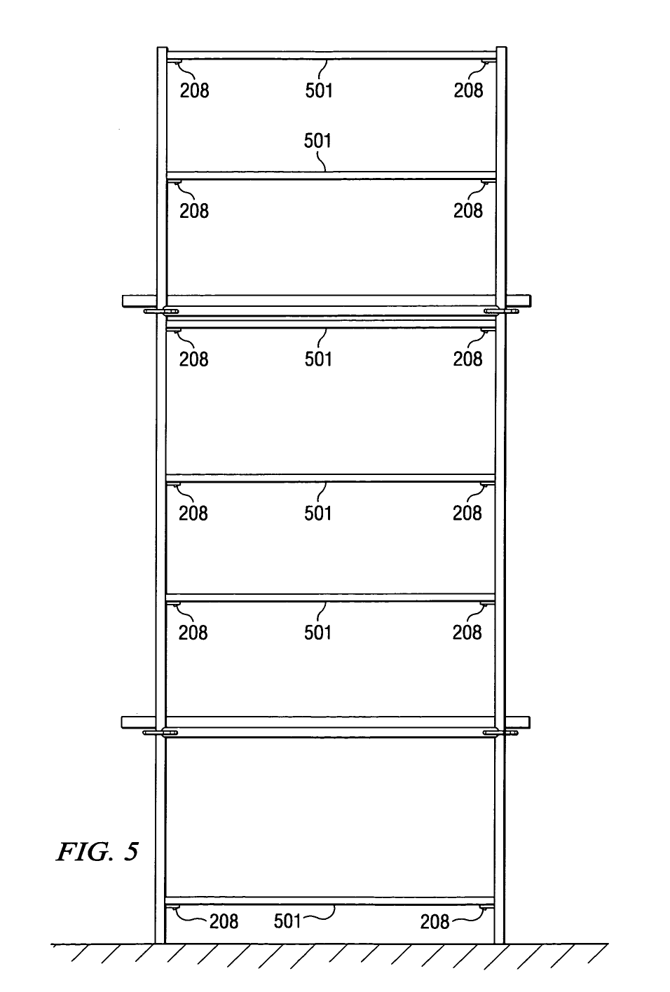

Referring now to FIG. 5, in a front view, end frame 201C is shown stacked on end frame 201A and end frame 201D is shown stacked on end frame 201B. As seen therein, connecting members or ledgers 501 are attached or coupled to coupling points 208 and serve to further strengthen the scaffold. Ledgers are available in different lengths, depending on the scaffolding bay length, deck type and load. As used herein, a connecting member can be inter alia, a tubular member serving as a diagonal, cross or squaring brace and/or knee-rails and/or handrails. The first end of a first connecting member of a plurality of connecting members is positioned and coupled to the first vertical member of the first end frame positioned so as to be orthogonal to the horizontal member of the first end frame. The second end of the first connecting member is positioned and coupled to a first vertical member of the second end frame and positioned so as to be orthogonal horizontal member of the second end frame. If the connecting member is a hand rail or guard rail, then the connecting member is positioned coupled in the z-axis so as to be substantially orthogonal to both the vertical member (y-axis) and the horizontal member (z-axis). If the connecting member is a diagonal brace, then the brace spans the z-axis and the y-axis.

Further connecting members are coupled to the vertical member to act as guardrails, knee rails, horizontal braces or diagonal braces. In an embodiment, two apositioned sides of the four-sided scaffold structure are end frames, one side is comprised of diagonal braces in an X-configuration and the other side is comprised of handrails and knee rails

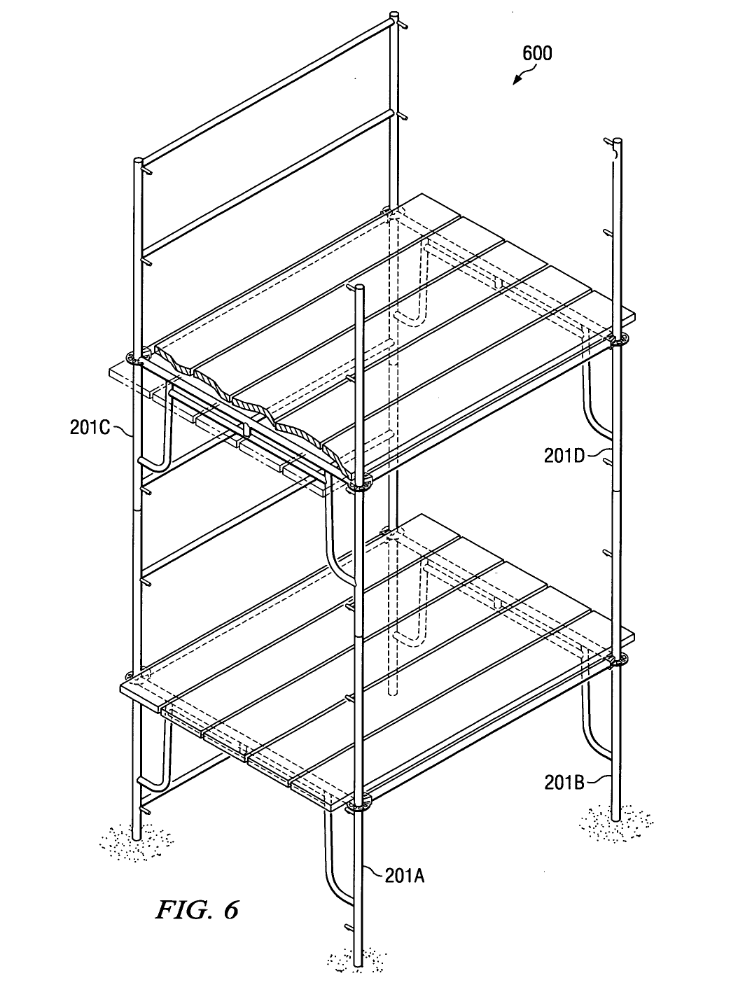

FIG. 6 is a perspective view of the invention 600 showing two end frames stacked on two end frames creating two elevations. As seen therein, the right hand side of the structure without ledgers is typically tied or attached to the building or structure under repair or construction.

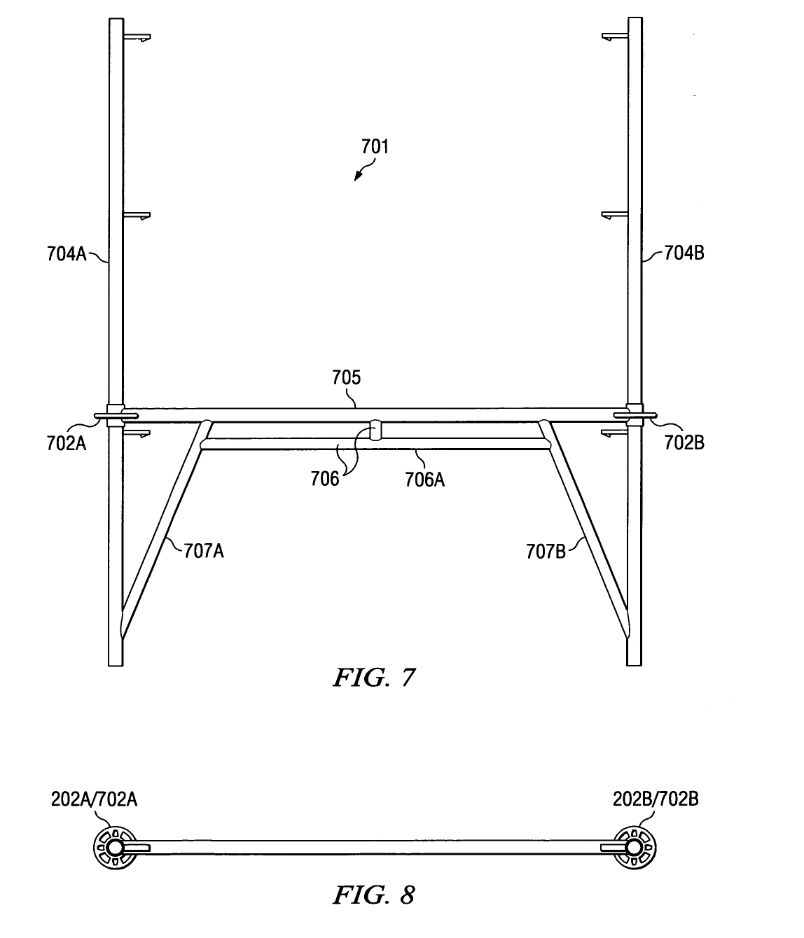

FIG. 7 is an alternative embodiment of the end frame of the invention. End frame 701 further includes a header or base support comprising a truss arrangement 706 welded below, and parallel to, the horizontal member 705 in the same plane of the horizontal member 705, the truss arrangement 706 being positioned between the first vertical member 704A and second vertical member 704B. The header 706A of truss arrangement 706 is between ⅓ and ⅔ of the distance from the lower end to the upper end of the vertical members 704A, 704B.

Below the horizontal member 705 is a first angled brace 707A having a first end thereof welded or coupled proximate to the lower end of the first vertical member 704A, extending at an angle from the first vertical member 704A and meeting the bottom side of the horizontal member 705, the first angled brace 707A being in the plane of the end frame 701 and a second angled brace 707B below the horizontal member 705 having a first end thereof welded or coupled proximate to the lower end of the second vertical member 704B, extending at an angle from the second vertical member 704B and meeting the bottom side of the horizontal member 705, the second angled brace 707B being in the plane of the end frame 701A, the end frame 701A being symmetrical along an imaginary vertical axis down the center of the end frame 701A.

FIG. 8 is a top view of end frame 201/701 illustrating rosettes 202A/702A. The rosette is further described herein with reference to rosettes 202 but is equally applicable to rosettes 702 used on the end frame 701.

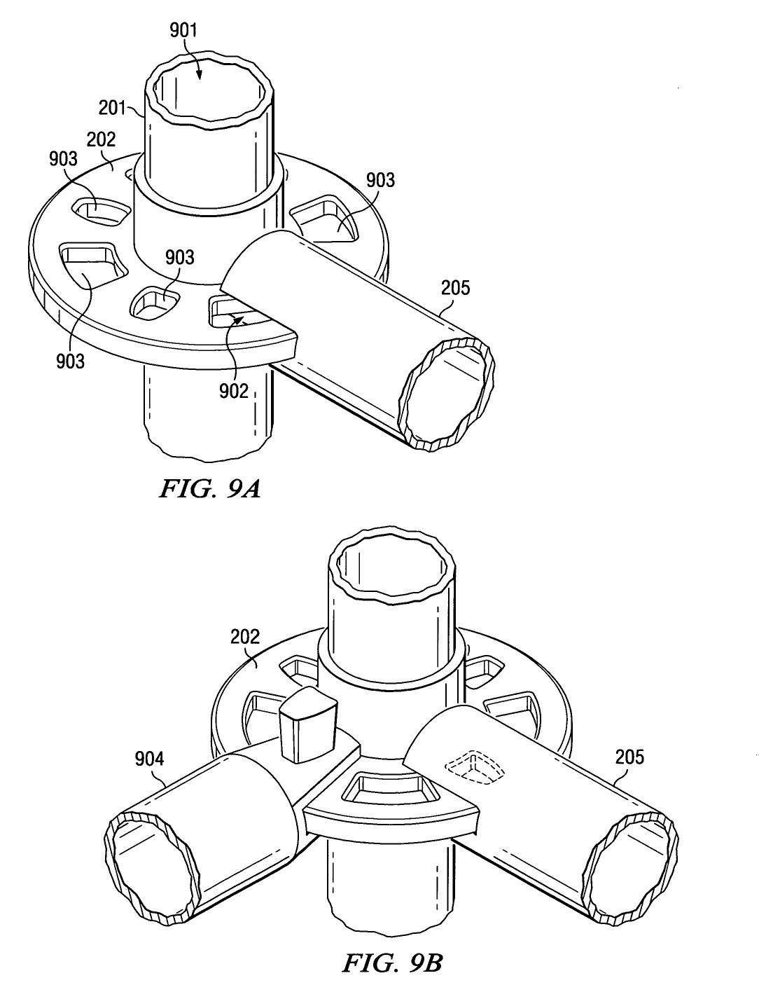

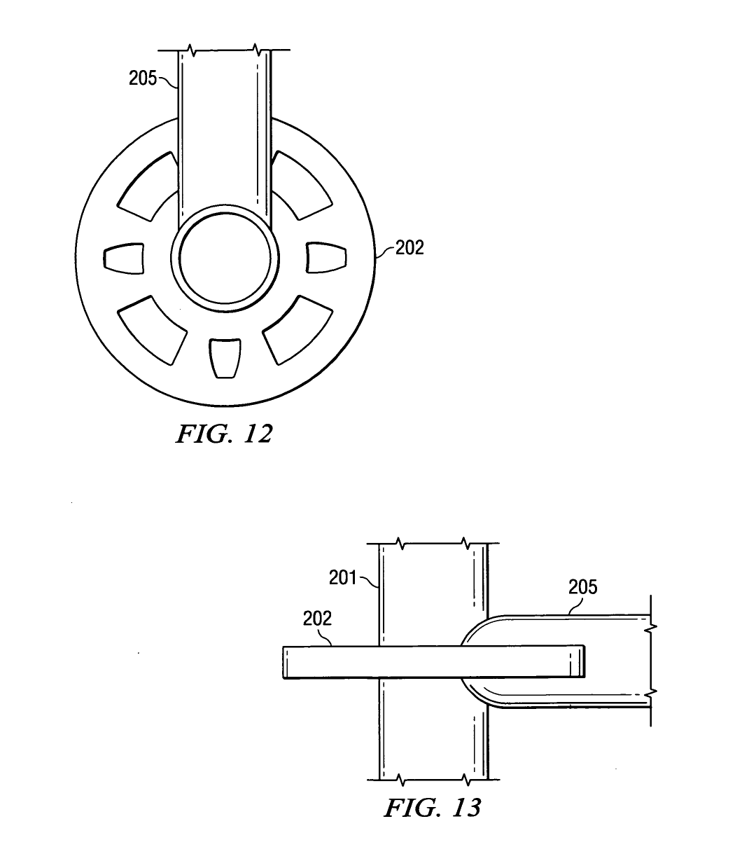

As seen in FIG. 9A, rosette 202 is shown axially coupled to vertical member 204 with horizontal member 205 coupled thereto. As seen therein, rosette 202 includes a central aperture 901 and partial cut-out 902 to receive the horizontal member 204. This is seen in FIGS. 12 and 13. As seen therein, the rosette 202 further has openings 903 around the interior periphery to facilitate connections of other horizontal members, such as ledgers or braces. The openings around the interior periphery of the rosette can be dimensioned to receive horizontal members similar to those disclosed in Applicant's co-pending U.S. Regular application Ser. No. 12/930,921 filed on Jan. 20, 2011, entitled “SCAFFOLD SYSTEM AND METHOD” and U.S. Regular application Ser. No. 13/065,562 filed on Mar. 24, 2011, entitled “HYBRID SCAFFOLD SYSTEM”. Further embodiments of the invention include additional rosettes coupled or integrated to the vertical member at predetermined lengths along the vertical member 201.

As seen in FIG. 9B, patterned openings 901 permit connections of connecting members or ledgers 904 at a variety of angles with respect to the horizontal member 205. As seen therein, slotted head having a slot (or gap) is placed at the end of such horizontal cross member or ledger and then the slot is positioned over the rosette so as to align the slot of the head with the aperture of the rosette as seen in FIG. 5. A wedge can then be hammered into the slot to couple the horizontal member to the integrated rosette which is integral to the vertical member as to couple the horizontal member to the rosette. Alternatively to the use of a wedge, a rosette and head arrangement similar to that invented by Applicant can be used (as seen, inter alia, in U.S. patent application Ser. Nos. 12/930,921 and U.S. patent application Ser. No. 13/065,562). In such case, the head positioned over the rosette and an internal wedge locks the head onto the rosette.

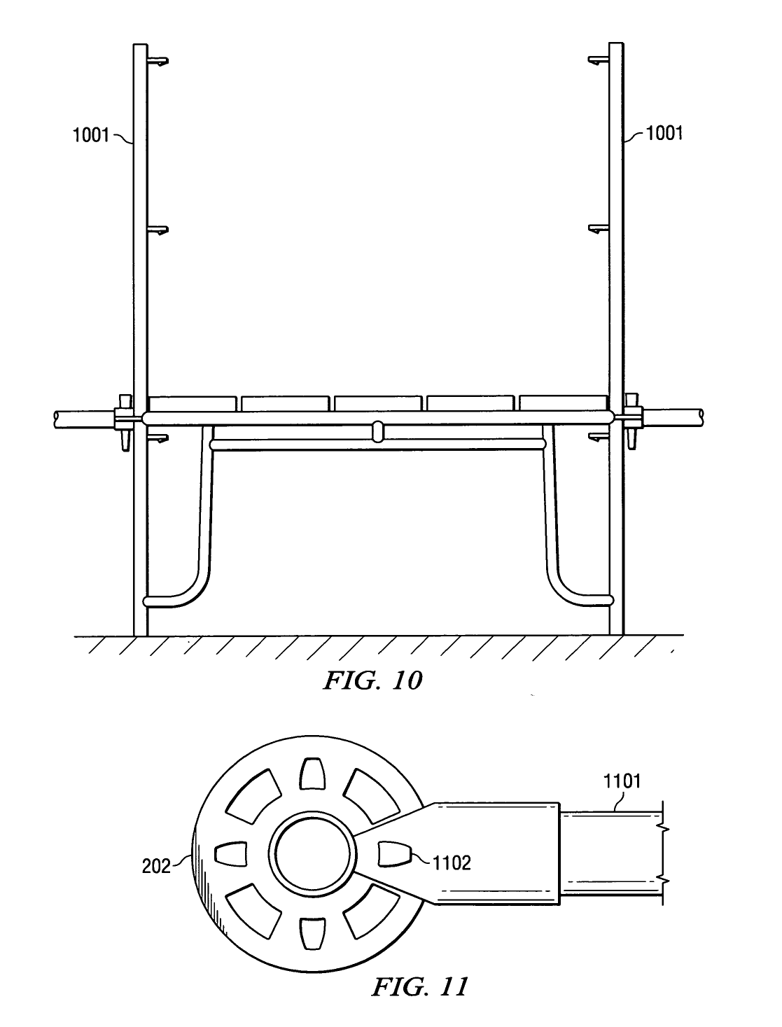

The scaffold apparatus further includes a second end frame similar to the first end frame, apositioned the first end frame when coupled with connecting members as hereinafter described. FIG. 10 is a side of an alternative embodiment of an end frame 1001 of the invention showing the attachment of additional horizontal members to the rosettes. FIG. 11 is a top view of rosette 201 having coupled thereto ledger 1101 via wedge 1102.

The vertical members and horizontal members used in the invention include but are not limited to high strength structural steel tubing, including steel that has been powder coated. The coupling mechanisms include, but are not limited to: frame locks, rosettes/collars and wedges, cam and rosette/collar arrangements, bolts, pin and aperture, insert and stacking pins, cotter pin and aperture, rivet and cotter, hinge or snap pin, spring rivet or pig tail, spars, clevis, collars and pins, and the like. Further the lower end of the vertical members can be configured to receive a locking caster or base plate, with or without a leveling jack to be used when the respective end frames are used in the first elevation.

As noted above, the header of the end frame 201/701/1001 of the invention can be located proximate the center of the end frame, about 3-3.5 feet from the lower end of the vertical members.

By moving the header to the middle of the end frame, it eliminates the need for extra supports that are typically welded to the vertical members. Notably, a 3-3.5 foot length tubular member is stronger than a 6′-6″ length tubular member and is less likely to fail if unsupported and the removal of the support reduces the costs associated with fabricating the scaffold members.

The structural arrangement of the invention further enables a novel method of erecting a scaffold system. Currently, an erector will install the scaffold frames by stacking them vertically at their feet and connecting them with the cross braces. After the frame is in place, the erector will install the decking or planking. Once the planking is secure the erector will then climb up the frame and start the process again. Once the erector climbs up to the next elevation he/she is subjected to falls as there are no handrails or knee rails at the next elevation. The erector is not protected during the installation of the then current frame elevation.

In contrast, the invention allows an erector to stack the frame by lifting it into place instead of stacking it at their feet. With the invention, the erector will connect the proper hands rails at heights mandated by regulations, e.g., as promulgated by OSHA, then lift the frame into place. The erector will then continue this step until the entire length of the facade elevation is complete. After the frames and handrails are installed at an elevation, the erector will then install the decking or planking. Then the erector will climb the scaffold to the next elevation where all of the guard rails have are already been positioned and coupled thus greatly reducing or eliminating the fall hazard.

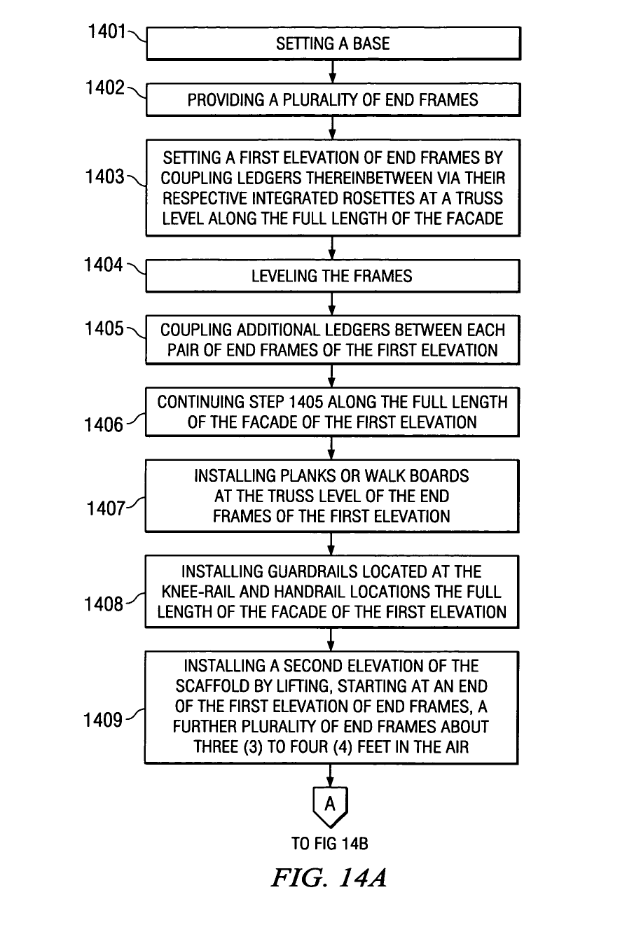

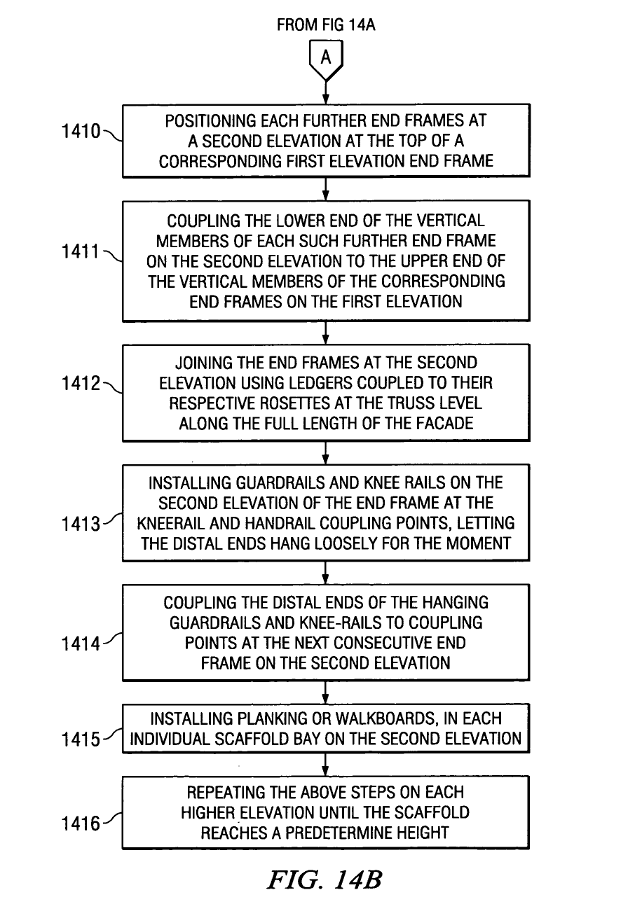

In an embodiment of the invention, the erector performs the following steps as seen in FIG. 14: Setting a base 1401, providing a plurality of end frames 1402, each comprised of a pair of parallel vertical members having upper and lower ends, the vertical members connected by an orthogonal truss arrangement having a horizontal member, the horizontal member being located approximately three (3) to three and a half (3.5) feet from the lower end of the vertical members. Then setting a first elevation of end frames by coupling ledgers to integrated rosettes at a truss level therein-between the end frames along the full length of the facade 1403; leveling the frames 1404; coupling additional ledgers between each pair of the end frames 1405; and continuing step 1404 along the full length of the facade. Then installing planks or walk boards at the truss level of the first elevation 1407; and installing guardrails located at the knee-rail and handrail locations the full length of the facade of the first elevation 1408. The method further includes the steps of installing a second elevation of the scaffold by lifting, starting at an end of the first elevation, a further plurality of end frames about three (3) to four (4) feet in the air 1409 and positioning each further end frames at the top of a corresponding first elevation end frame 1410 and then coupling the lower end of the vertical members of each such further end frame of the second elevation to the upper end of the vertical members of the corresponding end frame on the first elevation 1411. The method further includes joining the end frames at the second elevation using ledgers coupled to their respective rosettes at the truss level along the full length of the facade 1412 and installing guardrails and knee rails on the second elevation of the end frame at the knee-rail and handrail coupling points and let the distal ends hang loosely for the moment 1413 and coupling the distal ends of the hanging guardrails and knee-rails to coupling points on the next consecutive end frames on the second elevation 1414. The method further includes installing planking or walk boards, in each individual scaffold bay on the second elevation 1415. The method further comprises repeating the steps above each higher elevation until the scaffold reaches a predetermined height 1416.

The embodiments shown and described above are only exemplary. When reference is made to 201/701, it is referring to an exemplary structure, equivalent 201A, 201B, 201C, 201D, etc., and 701A, 701B, 701C, 701D, etc., and likewise to other structures having multiple equivalent components. Even though numerous characteristics and advantages of embodiments of the invention have been set forth in the foregoing description together with details of the invention, the disclosure is illustrative only and changes may be made within the principles of the invention to the full extent indicated by the broad general meaning of the terms used herein.

I claim:

1. A scaffold structure, comprising:
an end frame further comprising a first vertical member with an upper end and lower end;
a second vertical member with an upper end and a lower end;
a horizontal member having a first end and second end, the first end of the horizontal member welded or coupled orthogonally to the first vertical member between approximately ⅓ and ⅔ of the length of the first vertical member and the second end of the horizontal member is welded or coupled orthogonally to the second vertical member also between approximately ⅓ and ⅔ of the length of the second vertical member; and
a header comprising a truss arrangement below, and parallel to, the horizontal member in the same plane of the horizontal member, the truss arrangement being positioned between the first vertical member and second vertical member, the header of truss arrangement between ⅓ and ⅔ of the distance from the lower end to the upper end of the vertical member.

2. The scaffold structure of claim 1, further comprising the horizontal member having a first brace having a first end thereof coupled proximate to the lower end of the first vertical member, extending from the first vertical member and meeting the bottom side of the horizontal member, the first brace being in the plane of the end frame and a second brace below the horizontal member having a first end thereof coupled proximate to the lower end of the second vertical member and extending from the second vertical member and meeting the bottom side of the horizontal member, the second brace being in the plane of the end frame.

3. The scaffold structure of claim 2, wherein the first brace and second brace are curved members that extend orthogonally from their respective vertical members and curve upward to the bottom side of the horizontal member.

4. The scaffold structure of claim 2, wherein the first brace and second brace are straight members that extend at an angle from their respective vertical members and extend to the bottom side of the horizontal member at an acute angle.

5. The scaffold structure of claim 2, further comprising a rosette axially coupled to each vertical member.

6. The scaffold structure of claim 5, wherein the rosette is configured to receive at least one horizontal cross member.

7. The scaffold structure of claim 5, further comprising coupling points disposed along each of the extent of the vertical members to receive connection members, braces, handrails and/or knee rails.

8. The scaffold structure of claim 1, further comprising:
a first end frame and a second end frame, the two end frames apositioned to each other;
a first ledger having a first end and a second end, the first end of the first ledger coupled to a first rosette of the first end frame at an approximate 90 degree angle to the horizontal member of the first end frame;
the second end of the first ledger coupled to a first rosette of the second end frame at an approximate 90 degree angle to the horizontal member of the second end frame;
a second ledger having a first end and a second end, the first end of the second ledger coupled to a second rosette of the first end frame at an approximate 90 degree angle to the horizontal member of the first end frame and in the same direction of the first ledger; and
the second end of the second ledger coupled to a second rosette of the second end frame at an approximate 90 degree angle to the horizontal member of the second end frame, the foregoing forming a first scaffold bay at a first elevation.

9. The scaffold structure of claim 8, further comprising planks positioned across the horizontal members forming a platform.

10. The scaffold structure of claim 9, the platform having a width of approximately five (5) feet.

11. The scaffold structure of claim 10, further comprising a plurality of connecting members coupling the first frame to the second frame at coupling points disposed along each of the extent of the vertical members of each first frame and second frame.

12. The scaffold structure of claim 11, comprising a third and a fourth end frame stacked on the first and the second end frame, respectively, with a third ledger and fourth ledger coupling the third frame to the fourth frame from each vertical member thereof to form a second bay at a second elevation.

13. The scaffold structure of claim 12, comprising a plurality of end frames and connecting members comprising a plurality of bays at a plurality of elevations.

14. A method of building a scaffold, comprising:
a. setting a base;
b. providing a plurality of end frames, each comprised of a pair of parallel vertical members having upper and lower ends, the vertical members connected by an orthogonal truss arrangement having a horizontal member, the horizontal member being located approximately three (3) to three and a half (3.5) feet from the lower end of the vertical members;
c. setting a first elevation of end frames by coupling ledgers to integrated rosettes at a truss level therein-between the end frames along the full length of the facade;
d. leveling the frames;
e. coupling additional ledgers between each pair of the end frames;
f. continuing step (e) along the full length of the facade;
g. installing planks or walk boards at the truss level of the first elevation; and
h. installing guardrails located at the knee-rail and handrail locations the full length of the façade of the first elevation.

15. The method of claim 14, further comprising:
i. installing a second elevation of the scaffold by lifting, starting at an end of the first elevation, a further plurality of end frames about three (3) to four (4) feet in the air;
positioning each further end frames at the top of a corresponding first elevation J. end frame;
k. coupling the lower end of the vertical members of each such further end frame of the second elevation to the upper end of the vertical members of the corresponding end frame on the first elevation;
l. joining the end frames at the second elevation using ledgers coupled to their respective rosettes at the truss level along the full length of the facade;
m. installing guardrails and knee rails on the second elevation of the end frame at the knee-rail and handrail coupling points and let the distal ends hang loosely for the moment;
n. coupling the distal ends of the hanging guardrails and knee-rails to coupling points on the next consecutive end frames on the second elevation;
o. installing planking or walk boards, in each individual scaffold bay on the second elevation.

16. The method of claim 15, further comprising repeating steps of claim 15 on each higher elevation until the scaffold reaches a predetermined height.
